(19) United States
(12) Patent Application Publication
(10) Pub. No.: US 2026/0359117 A1
(43) Pub. Date: Nov. 12, 2026

(54) RESOURCE ALLOCATION SYSTEMS AND RELATED METHODS

(71) Applicant: The Toronto-Dominion Bank, Toronto (CA)

(72) Inventors: Jeremy John McCONNELL, Ottawa (CA); Adrian BLOY, Orleans (CA)

(21) Appl. No.: 19/204,852

(22) Filed: May 12, 2025

(51) Int. Cl. G06F 9/50; G06F 16/25

(52) U.S. Cl. CPC G06F 9/5005; G06F 16/252

(57) ABSTRACT

Systems and methods for dynamic resource allocation. A processor receives, from a terminal computing device, a resource allocation query containing query session data, which includes a query terminal identifier and a query client identifier. A query session type is determined based on the query session data, the query session type being one of the plurality of session types from the database. Using the query session type, the processor obtains a query resource allocation rate from the plurality of resource allocation rates stored in the database. The processor then determines a first resource allocation and a second resource allocation based at least on the query session data and the query resource allocation rate, and appends a record of the first resource allocation to a first resource database associated with the client identifier and a record of the second resource allocation to a second resource allocation database associated with the client identifier.

### TECHNICAL FIELD

This application relates generally to resource allocation, and in particular to systems and methods for determining a resource allocation for a session.

### BACKGROUND

Various events or sessions can require resources. In some cases, more than one resource can be allocated for a certain session. For example, a portion of the session can be fulfilled by a first resource and another portion of the session can be fulfilled by another resource. The allocation between the different resources can vary.

Conventional systems and methods for resource allocation are often performed off-line, such as retrospectively (i.e., after an event has taken place) or prospectively based on forecasted or anticipated events. However, retrospective resource allocation is typically based on static factors, which can be inefficient as it does not allow adjustment of resources based on dynamic factors. With respect to prospective resource allocation, the forecast may not reflect the actual event and the allocation may not account for dynamic factors that have changed since the forecast.

### SUMMARY

It should be appreciated that this summary is provided to introduce a selection of concepts in a simplified form that are further described below in the detailed description. This summary is not intended to be used to limit the scope of the claimed subject matter.

In a first broad aspect, there is provided resource allocation system comprising: a database storing a plurality of session types in association with a plurality of resource allocation rates; and a processor and a memory storing instructions, the instructions, when executed by the processor, cause the processor to: receive, from a terminal computing device, a resource allocation query comprising query session data, the query session data comprising a query terminal identifier and a query client identifier; determine a query session type based to the query session data, the query session type being one of the plurality of session types from the database; using the query session type, obtain a query resource allocation rate from the plurality of resource allocation rates stored in the database; determine a first resource allocation and a second resource allocation based at least on the query session data and the query resource allocation rate; and append a record of the first resource allocation to a first resource database associated with the client identifier and a record of the second resource allocation to a second resource allocation database associated with the client identifier.

In some cases, the instructions further cause the processor to: compare the query session type with the plurality of session types; and in response to determining that the query session type matches a particular session type of the plurality of session types, use the resource allocation rate associated with the particular session type as the session resource allocation rate; otherwise, assign a default resource allocation rate to the query resource allocation rate.

In some cases, the query session data comprises a query session date and time, and the instructions further cause the processor to: determine whether the session date and time falls within a pre-defined date and time period; and in response to determining that the session date and time falls within the pre-defined date and time period, use a limited time resource allocation rate as the query resource allocation rate; otherwise, use a standard resource allocation rate as the query resource allocation rate.

In some cases, the limited time resource allocation rate is a pre-defined multiplier applied to the standard resource allocation rate.

In some cases, the database further comprises a plurality of terminal identifiers in association with the plurality of session types; and wherein the instructions further cause the processor to: compare the query terminal identifier with the plurality of terminal identifiers; and in response to determining that the query terminal identifier matches a particular terminal identifier of the plurality of terminal identifiers, use the session type associated with the particular terminal identifier as the query session type; otherwise assign a default session type to the query session type.

In some cases, the database further comprises a plurality of terminal category codes in association with the plurality of session types; and wherein: the query session data comprises a query terminal category code; and the instructions further cause the processor to: compare the query terminal category code with the plurality of terminal category codes; and in response to determining that the query terminal category code matches a particular terminal category code of the plurality of terminal category codes, use the session type associated with the particular terminal category code as the query session type; otherwise assign a default session type to the query session type.

In some cases, the query session data comprises a query first resource value, and the instructions further cause the processor to: determine a client second resource amount from the second resource allocation database associated with the client identifier; generate a client second resource value based on the client second resource amount and the query resource allocation rate; compare the query first resource value to the client second resource value; and in response to determining that the client second resource value is at least the query first resource value, use the query first resource value as a proposed second resource allocation and nil as a proposed first resource allocation; otherwise, in response to determining that the client second resource value is less than the query first resource value, use the client second resource value as the proposed second resource allocation and a difference between the query first resource value and the client second resource value as the proposed first resource allocation.

In some cases, the instructions further cause the processor to: transmit the proposed first resource allocation and the proposed second resource allocation to the terminal computing device for either approval or rejection prior to appending the record of the first resource allocation to the first resource database and the record of the second resource allocation to the second resource allocation database; and in response to receiving approval of the proposed first resource allocation and the proposed second resource allocation from the terminal computing device, use proposed first resource allocation as the first resource allocation and the proposed second resource allocation as the second resource allocation; otherwise, in response to receiving rejection of the proposed first resource allocation and the proposed second resource allocation from the terminal computing device, generate an alternative proposed first resource allocation and an alternative proposed second resource allocation.

In some cases, the instructions further cause the processor to append a record of the query first resource value to a first resource allocation database associated with the terminal identifier.

In another broad aspect, there is provided a method comprising operating a processor to: receive a resource allocation query comprising query session data, the query session data comprising a query terminal identifier and a query client identifier; determine a query session type based to the query session data, the query session type being one of a plurality of session types stored in a database; using the query session type, obtain a query resource allocation rate from the plurality of resource allocation rates stored in association with the plurality of session types in the database; determine a first resource allocation and a second resource allocation based at least on the query session data and the query resource allocation rate; and append a record of the first resource allocation to a first resource database associated with the client identifier and a record of the second resource allocation to a second resource allocation database associated with the client identifier.

In some cases, the method further comprises: comparing the query session type with the plurality of session types; and in response to determining that the query session type matches a particular session type of the plurality of session types, using the resource allocation rate associated with the particular session type as the session resource allocation rate; otherwise, assigning a default resource allocation rate to the query resource allocation rate.

In some cases, the query session data comprises a query session date and time, and the method further comprises: determining whether the session date and time falls within a pre-defined date and time period; and in response to determining that the session date and time falls within the pre-defined date and time period, using a limited time resource allocation rate as the query resource allocation rate; otherwise, using a standard resource allocation rate as the query resource allocation rate.

In some cases, the limited time resource allocation rate is a pre-defined multiplier applied to the standard resource allocation rate.

In some cases, the method further comprises comparing the query terminal identifier with a plurality of terminal identifiers stored in association with the plurality of session types in the database; and in response to determining that the query terminal identifier matches a particular terminal identifier of the plurality of terminal identifiers, using the session type associated with the particular terminal identifier as the query session type; otherwise assigning a default session type to the query session type.

In some cases, the query session data comprises a query terminal category code; and the method further comprises comparing the query terminal category code with the plurality of terminal category codes stored in association with the plurality of session types in the database; and in response to determining that the query terminal category code matches a particular terminal category code of the plurality of terminal category codes, using the session type associated with the particular terminal category code as the query session type; otherwise assigning a default session type to the query session type.

In some cases, the query session data comprises a query first resource value, and the method further comprises determining a client second resource amount from the second resource allocation database associated with the client identifier; generating a client second resource value based on the client second resource amount and the query resource allocation rate; comparing the query first resource value to the client second resource value; and in response to determining that the client second resource value is at least the query first resource value, using the query first resource value as a proposed second resource allocation and nil as a proposed first resource allocation; otherwise, in response to determining that the client second resource value is less than the query first resource value, using the client second resource value as the proposed second resource allocation and a difference between the query first resource value and the client second resource value as the proposed first resource allocation.

In some cases, the method further comprises transmitting the proposed first resource allocation and the proposed second resource allocation for either approval or rejection prior to appending the record of the first resource allocation to the first resource database and the record of the second resource allocation to the second resource allocation database; and in response to receiving approval of the proposed first resource allocation and the proposed second resource allocation, using proposed first resource allocation as the first resource allocation and the proposed second resource allocation as the second resource allocation; otherwise, in response to receiving rejection of the proposed first resource allocation and the proposed second resource allocation, generating an alternative proposed first resource allocation and an alternative proposed second resource allocation.

In some cases, the method further comprises appending a record of the query first resource value to a first resource allocation database associated with the terminal identifier.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

Embodiments will now be described more fully with reference to the accompanying drawings, in which like reference numerals denote like parts throughout the several views, and in which:

FIG. 1 is a schematic block diagram of an exemplary resource allocation system, in accordance with some embodiments; and

FIG. 2 is a flowchart of an exemplary method for determining resource allocation for a session, in accordance with some embodiments.

The drawings, described below, are provided for purposes of illustration, and not limitation, of the aspects and features of various examples of embodiments described herein. For simplicity and clarify of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

The systems and methods disclosed herein allocate resources in real-time, upon receipt of a resource request. A resource request can be initiated based on an event, occurrence, or session taking place in real-time. Thus, the allocation can be determined online based on various dynamic factors. Often, the dynamic factors relate to information not available to a computing device at which the session takes place.

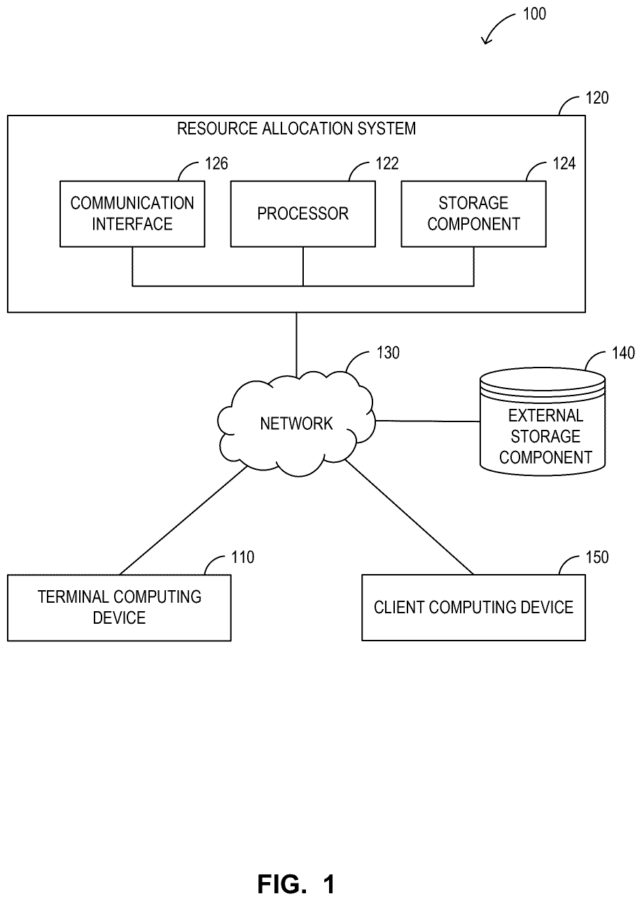

Referring now to FIG. 1, there is illustrated a schematic block diagram 100 of an exemplary resource allocation system 120, in accordance with at least some embodiments. The system 120 includes a processor 122, a storage component 124, and a communication interface 126. The system 120 can be a server including but not limited to, for example, a hardware server, virtual server, cloud server etc. Generally, the system 120 can allocate resources for sessions between clients and terminals. The system 120 can maintain records of resources of clients associated with a client identifier and terminals associated with a terminal identifier.

The storage component 124, or memory, can include RAM, ROM, one or more hard drives, one or more flash drives or some other suitable data storage elements such as disk drives. For example, the storage component 124 can include volatile and non-volatile memory. Non-volatile memory can store computer programs consisting of computer-executable instructions, which can be loaded into the volatile memory for execution by the processor 122. Operating the processor 122 to carry out a function can involve executing instructions (e.g., a software program) that can be stored in the storage component 124 and/or transmitting or receiving inputs and outputs via the communication component 126. The storage component 124 can also store data input to, or output from, the processor 122, which can result from the course of executing the computer-executable instructions, for example.

The storage component 124 can store data received from a computing device, such as terminal computing device 110 or client computing device 150. The storage component 124 can also store software applications executable by the processor 122 to facilitate communication between the system 120 and the terminal computing device 110, and configuration of the terminal computing device 110.

The storage component 124 can include one or more databases for storing data related to clients, terminal computing devices 110, sessions, and resources. The one or more databases can be any type of database including, but not limited to a relational database, network database, object-oriented database, non-relational or NoSQL database etc. Data related to sessions can include session types as well as resource allocation rates associated with the session types.

Data related to clients, or users, can include a client identifier. Upon enrollment to the resource allocation system 120, each client or user can be assigned a unique client identifier. For example, the client identifier can be a username or an account number or similar. The client or user can provide their client identifier at a computing device, such as client computing device 150 or terminal computing device 110, to access the resource allocation system 120. The client identifier allows resources to be routed to the correct client. The database can also store records of resources associated with each client identifier. For example, the database can store records of a first resource associated with a client identifier as well as records of a second resource associated with the client identifier.

Data related to terminal computing devices 110 can include a terminal identifier. The terminal identifier allows resources to be routed to the correct terminal. In some embodiments, a plurality of terminal computing devices 110 can relate to a terminal identifier. That is, a fleet of terminal computing devices 110 can relate to a terminal identifier. The terminal identifier can have a sub-identifier that is unique to each terminal computing device 110 of the fleet. In some embodiments, the database can store session types associated with the terminal identifiers. In some embodiments, the database can also store terminal category codes associated with the terminal identifiers. Terminal category codes can represent a category to which the terminal identifier relates to. More specifically, terminal category codes can reflect a category of an object of a session receivable from the terminal identifier. Terminal category codes can be standardized classifications. For example, terminal category codes can be a four-digit code. Terminal category codes can be assigned to terminal identifiers upon enrollment to the resource allocation system 120 and updated (e.g., added, or removed) as needed. In some embodiments, the database can also store records of resources associated with each terminal identifier. For example, the database can store records of a first resource associated with a terminal identifier.

The processor 122 can control the operation of the system 120. The processor 122 can include any suitable processors, controllers, digital signal processors, graphics processing units, application specific integrated circuits (ASICs), field programmable gate arrays (FPGAs), microcontrollers, and/or other suitably programmed or programmable logic circuits that can provide sufficient processing power depending on the configuration, purposes and requirements of the system 120. In some embodiments, the processor 122 can include more than one processor with each processor being configured to perform different dedicated tasks.

The communication component 126 can include any interface that enables the system 120 to communicate with various devices and other systems. For example, the communication component 126 can facilitate communication with terminal computing device 110, client computing device 150, and external storage component 140 via the communication network 130. Although only one terminal computing device 110, one client computing device 150, and one external storage component 140 is shown in FIG. 1, the communication component 126 can facilitate communication with any number of terminal computing devices 110, client computing devices 150, and external storage components 140.

In some embodiments, the communication component 126 can include at least one of a serial port, a parallel port, or a USB port. The communication component 126 may also include a wireless transmitter, receiver, or transceiver for communicating with a wireless communications network, such as the communication network 130. The wireless communications network can include at least one of an Internet, Local Area Network (LAN), Ethernet, Firewire, modem, fiber, or digital subscriber line connection. Various combinations of these elements may be incorporated within the communication component 126. For example, the communication component 126 may receive input from various input devices, such as a mouse, a keyboard, a touch screen, a thumbwheel, a trackpad, a trackball, a card-reader, voice recognition software and the like depending on the requirements and implementation of the system 120.

The communication network 130 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi®, WiMax®), Signalling System No. 7(SS7 ) network, fixed line, local area network, wide area network, and others, including any combination of these, capable of interfacing with, and enabling communication between the system 120, the terminal computing device 110 and/or the external storage component 140.

In some embodiments, the terminal computing device 110 can communicate with other terminal computing devices 110 and/or client computing devices 150 via the communication network 130. In some embodiments, the terminal computing device 110 can communicate with other terminal computing devices 110 and/or client computing devices 150 directly via onboard communication components. For example, each terminal computing device 110 and the system 120 can be equipped with a wireless communication interface to enable wireless communications according to a Wi-Fi protocol (e.g., IEEE 802.11 protocol or similar).

Similar to the storage component 124, the external storage component 140 can include RAM, ROM, one or more hard drives, one or more flash drives or other suitable data storage elements such as disk drives. Similar to the storage component 124, the external storage component 140 can store data in respect of the system 120, the terminal computing devices 110, and/or client computing devices 150, including data related the terminal computing devices, clients, sessions, and resources. Data can be stored in the external storage component 140 for subsequent retrieval by the system 120, client computing devices 150, and/or the terminal computing devices 110. Although the external storage component 140 is described and shown as separate from the system 120, other configurations are possible. In some embodiments, the external storage component 140 is hosted by the system 120. In some embodiments, the external storage component 140 can be a third-party data storage.

In some embodiments, one or more computing devices, such as terminal computing device 110 and client computing device 150 can communicate with the system 120 via the communication network 130. The terminal computing device 110 and the client computing device 150 can include any device capable of communication with other devices through a network such as the communication network 130. The terminal computing device 110 and the client computing device 150 can include a processor and memory, and may be an electronic table, a personal computer, workstation, server, portable computer, mobile device, personal digital assistant, laptop, smart phone, Wireless Application Protocol (WAP) phone, an interactive television, video display terminals, portable electronic devices, a point-of-sale (POS) terminal, or any combination of these. Although only one terminal computing device 110 and one client computing device 150 is shown in FIG. 1 for simplicity, more computing devices can communicate with the system 120.

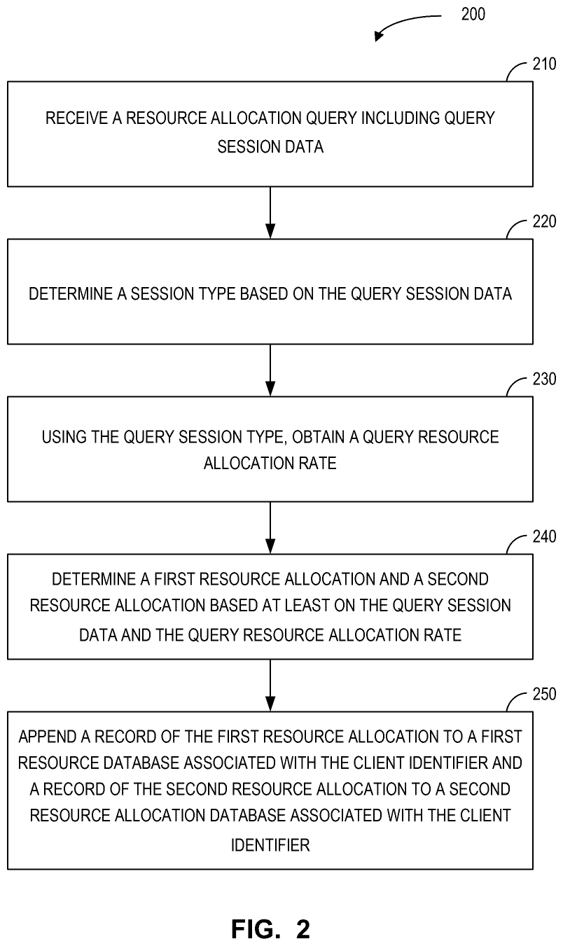

Reference now is made to FIG. 2, which is a flowchart of an example method 200 for allocating resources for a session. To assist with the description of method 200, reference will be simultaneously made to FIG. 1.

At 210, a processor, such as processor 122, can receive a resource allocation query from a terminal computing device, such as terminal computing device 110. The resource allocation query can be transmitted by the terminal computing device 110 to the processor 122 via network 130. The resource allocation query can include query session data. Query session data can include a terminal identifier, a client identifier, and a query first resource value. The terminal computing device 110 can generate the resource allocation query using a client identifier received at the terminal computing device 110 via an input device. In some embodiments, the terminal computing device 110 generates the resource allocation query using a client identifier received at directly the terminal computing device 110 via an input device or from a client computing device, such as client computing device 150 via network 130.

In some embodiments, a session can relate to a financial transaction, such as a credit card transaction, between a merchant associated with a terminal identifier and a customer associated with a client identifier. Further, the client identifier can relate to a loyalty redemption program. The merchant's terminal identifier can be a Merchant Identification Number (MID). The financial transaction can be a sale of products or services (e.g., groceries), having a monetary value. Accordingly, a merchant's point of sale device can transmit a resource allocation query to the system 120. The resource allocation query can include the query session data, such as but not limited to the terminal identifier, the client identifier, and the monetary value. Alternatively, the customer may transmit the resource allocation query associated with the transaction to the system 120 from another computing device following the transaction.

At 220, the processor 122 can determine a query session type based to the query session data. The processor 112 can select the query session type from a plurality of session types stored in a database. The database can be stored in storage component 124 (e.g., a memory or other storage device) or external storage component 140.

In some embodiments, the database can store a plurality of terminal identifiers in association with the plurality of session types. The processor 122 can compare the query terminal identifier with the plurality of terminal identifiers. In response to determining that the query terminal identifier matches a particular terminal identifier of the plurality of terminal identifiers, the processor 122 can use the session type associated with the particular terminal identifier as the query session type. Otherwise, in response to determining that the query terminal identifier does not match any terminal identifier stored in the database, the processor 122 can assign a default session type to the query session type.

In some embodiments, the query session data can include a query terminal category code. The query terminal category code can represent a category to which the terminal computing device 110 relates. The terminal category code can also represent a category for an object of the session or the event. The processor 122 can compare the query terminal category code with a plurality of terminal category codes stored in the database. The database can store a plurality of terminal category codes in association with the plurality of session types. In response to determining that the query terminal category code matches a particular terminal category code of the plurality of terminal category codes, the processor 122 can use the session type associated with the particular terminal category code as the query session type. Otherwise, in response to determining that the query terminal category code does not match any of the plurality of terminal category codes, the processor 122 can assign a default session type to the query session type.

Continuing with the above financial transaction example, the processor 122 can determine the query session type based on the terminal identifier, such as the MID. In some embodiments, the processor 122 can simply determine the query session system based on the terminal identifier.

In some embodiments, the merchant's query terminal category code can be a Merchant Category Code (MCC), which generally reflects the types of products and services that the merchant offers. MCCs can relate to any product or service, such as but not limited to travel, groceries, fuel, utilities, clothing, appliance stores, electronic stores, drug stores and pharmacies, restaurants, bookstores, department stores, dry cleaners, health and beauty shops, automotive repair shops, etc. For example, grocery store merchants can be assigned an MCC that relates to grocery stores. That is, a plurality of terminals can have a same query terminal category code. Further, merchants can be assigned more than one MCC. For example, a grocery store merchant can also offer clothing and eyeglasses, in addition to groceries. Accordingly, some terminal identifiers can be associated with a plurality of terminal category codes. The query category code can reflect the object of the session. For example, the query category code can be an MCC that relates to clothing for a sale of clothing at a grocery store. Accordingly, the processor 122 can determine the query session type based on the query terminal category code.

The query session type can also be indicative of whether the session generates resources. Continuing with the financial transaction example, a financial transaction can relate to a sale in which one or more resources are allocated to fulfill the monetary value of the sale. For example, a first resource can be money and a second resource can be a type of loyalty points. That is, a monetary amount and/or a number of points will be allocated to fulfill the monetary value of the sale. However, some financial transactions can relate to a sale that also generates resources. For example, a monetary amount will be allocated to fulfill the monetary value of the sale and a number of points will be accumulated based on the sale. In some embodiments, the number of points accumulated can be based on the monetary value of the sale and/or object of the sale. Although only two resources are described in this example, additional resources can be used. For example, a second type of loyalty points can also be used for the session.

At 230, the processor 122 can use the query session type to obtain a query resource allocation rate from a plurality of resource allocation rates stored in the database. The database can store the plurality of session types in association with a plurality of resource allocation rates. Resource allocation rates can represent a conversion rate between two types of resources.

Different session types can be associated with different resource allocation rates to increase efficiency of resource allocation. Continuing with the above financial transaction example, the resource allocation rate can be a conversion rate between loyalty points and a monetary value. Further, redeeming loyalty points against a travel type transaction can have a resource allocation rate that is different from the resource allocation rate of redeeming loyalty points against a grocery type transaction. For example, to encourage travel, the resource allocation rate associated with travel type transactions can be more favourable (i.e., lower number of points for same monetary value) than the resource allocation rate associated with grocery type transactions. In another example, to promote a particular merchant, the resource allocation rate associated with transactions with a particular terminal identifier can be more favourable (i.e., lower number of points for same monetary value) than the resource allocation rate associated with other merchant, even other merchants with the same terminal category code.

In some embodiments, the processor 122 can compare the query session type obtained at 230 with the plurality of session types stored in association with a plurality of resource allocation rates. In response to determining that the query session type matches a particular session type having an associated resource allocation rate, the processor 122 can use the resource allocation rate associated with the particular session type as the session resource allocation rate. Otherwise, in response to determining that the query session type does not match any session type having an associated resource allocation rate stored in the database, the processor 122 can assign a default resource allocation rate to the query resource allocation rate.

For example, when the query session type indicates that the financial transaction accumulates second resources, the resource allocation rate can be indicative that the query first resource value will be fulfilled entirely by the first resource.

In some embodiments, the query session data can include a query session date and time. The processor 122 can determine whether the session date and time falls within a pre-defined date and time period. The predefined date and time period can represent a limited time period in which a non-standard resource allocation rates apply. Outside of the limited time period, standard resource allocation rates can apply. The limited time period can for example, represent a promotional period to incentivize use of certain resources over others. For example, the limited time resource allocation rate can be a pre-defined multiplier applied to the standard resource allocation rate, such as but not limited to double or triple the standard resource allocation rate.

At 240, the processor 122 can determine a first resource allocation and a second resource allocation based at least on the query session data and the query resource allocation rate.

The processor 122 can determine a client second resource amount from a second resource allocation database associated with the client identifier. The processor 122 can generate a client second resource value based on the client second resource amount and the query resource allocation rate. The processor 122 can compare the query first resource value to the client second resource value. In response to determining that the client second resource value is at least the query first resource value, that is, the client second resource value is sufficient for fulfilling the query first resource value, the processor 122 can use the query first resource value as a proposed second resource allocation and nil as a proposed first resource allocation. Otherwise, in response to determining that the client second resource value is insufficient for fulfilling the query first resource value, the processor 122 can use the client second resource value as the proposed second resource allocation and a difference between the query first resource value and the client second resource value as the proposed first resource allocation. That is, the processor 122 can use the second client resource value to fulfill a portion of the query first resource value and the difference can be proposed first resource allocation.

In some embodiments, the proposed first resource allocation and the proposed second resource allocation can each be non-zero. Together, the proposed first resource allocation and the proposed second resource allocation can total the query first resource value.

In some embodiments, the proposed first resource allocation can be the query first resource value and the proposed second resource allocation can be nil. For example, when the query session type indicates that the financial transaction accumulates second resources, the proposed first resource allocation can be the query first resource value and the proposed second resource allocation can be nil. Further, the processor 122 can determine a second resource accumulation. The second resource accumulation can be based on query session data, including but not limited to the query first resource value, the client identifier, the terminal identifier, and/or a terminal category code.

In some embodiments, the processor 122 can transmit the proposed first resource allocation and the proposed second resource allocation to the terminal computing device 110 or the client computing device 150 for either approval or rejection. The terminal computing device 110 and/or the client computing device 150 can receive user input corresponding to approval or rejection. In response to receiving approval of the proposed first resource allocation and the proposed second resource allocation from the terminal computing device 110 or the client computing device 150, the processor 122 can use the proposed first resource allocation as the first resource allocation and the proposed second resource allocation as the second resource allocation. Otherwise, in response to receiving rejection of the proposed first resource allocation and the proposed second resource allocation, the processor 122 can generate an alternative proposed first resource allocation and an alternative proposed second resource allocation. In turn, the processor 122 can transmit the alternative proposed first resource allocation and the alternative proposed second resource allocation to the terminal computing device 110 or the client computing device 150.

In some embodiments, the alternative proposed first resource allocation and the alternative proposed second resource allocation can each be non-zero. Together, the proposed first resource allocation and the proposed second resource allocation can total the query first resource value. In some embodiments, the alternative proposed first resource allocation can be the query first resource value and the alternative proposed second resource allocation can be nil.

At 250, the processor 122 can append a record of the first resource allocation to a first resource database associated with the client identifier and a record of the second resource allocation to a second resource allocation database associated with the client identifier. In some embodiments, where the second resource allocation can represent to a second resource accumulation. The processor 122 can further determine a balance of each of the resources associated with the client identifier accounting for the query session, that is, the first resource allocation and the second resource allocation for the query session.

In some embodiments, the processor 122 can also append a record of the query first resource value to a first resource accumulation database associated with the terminal identifier. The processor 122 can further determine a balance of the first resources associated with the terminal identifier accounting for the query session, that, is the first resource accumulation for the query session.

In at least some embodiments, the described embodiments can be used to provide or enhance a loyalty program. The landscape for loyalty programs has grown increasingly competitive. In response, some financial services providers have formed partnerships with select merchants. Such partnerships can encourage or incentivize credit card holders to frequent partnered merchants. For example, such partnerships can offer enhanced points accumulation when the credit card is used with partnered merchants.

Conventional credit card loyalty programs generally follow standardized rules for accumulating points, which can include various mechanisms such as bonus point promotions, social category-based multipliers (e.g. higher points for dining, travel, gas purchased), and limited-time offers. However, despite these different accumulation methods, the process for redeeming points typically follows a static model. The redemption rate for points is generally predetermined by the terms and conditions of the credit card holders' account or specific credit card program and does not vary. This creates a lack of opportunities for credit card holders to draw value from their points based on individual spending behaviour or preferences. Further, in some cases, the redemption rate is only applied at the end of a billing cycle, that is, retrospectively. In some cases, points can be applied prospectively, but only via a specific points redemption portal, which the user may be unfamiliar with, that the user does not prefer.

In contrast, at least some embodiments of the described system can dynamically calculate redemption values for accrued loyalty points. This described system operates by maintaining a comprehensive database, or mapping table, that correlates Merchant Category Codes (MCCs) and Merchant Identifiers (MIDs) with corresponding redemption values. The loyalty program provider populates and maintains this table, incorporating data from credit card networks and adjusting it as desired from time-to-time.

In one scenario, a customer may attempt to redeem points for a purchase at a local grocery store. The system, upon receiving the redemption request, accesses the MCC/MID Mapping Table. The system identifies the MCC associated with the grocery store and determines a redemption rate of 100 points per dollar spent. In contrast, a subsequent redemption request for a purchase at a luxury hotel might trigger a different lookup in the same table, resulting in a redemption rate of 150 points per dollar spent, reflecting a more favorable agreement with the hotel chain. Furthermore, the redemption rate may differ for different customers, depending on a variety of factors, such as loyalty program status, number of accrued loyalty points, transaction history, promotions, and so forth.

To further illustrate the system's flexibility, consider a promotional campaign targeting travel purchases. During the month of December, the system may automatically adjust the redemption rate for all transactions categorized under travel-related MCCs. A customer redeeming points for an airline ticket now receives a bonus of 20 points per dollar spent, effectively increasing the value of their loyalty points for that specific transaction. This promotional adjustment is managed through a dedicated Promotional Campaign Management Module, allowing the loyalty program provider to define and activate targeted offers with ease.

The system may also incorporate an Exclusion Table, providing a mechanism to prevent dynamic redemption value calculations for specific merchants or categories. For example, the loyalty program provider might exclude transactions at certain high-end retailers. This exclusion is transparently managed within the system, ensuring consistent application of the redemption rules.

Furthermore, the system's architecture allows for integration with a Transaction Categorization System. This integration enables customers to manually tag their transactions with custom category codes, overriding the default MCC/MID assignment. This feature allows for a more granular level of redemption value calculation, reflecting the customer's intended use of the purchased goods or services. For instance, a customer might tag a purchase at a general merchandise store as “Home Improvement,” triggering a higher redemption rate than the default category would provide. The system may verify the tag and, if approved, the higher redemption rate may apply. Tags may be more granular than MCC codes, and the verification may involve, e.g., determining whether the tag is appropriate based on the MCC code, merchant name or MID, historical tagging by other customers, transaction value, and so forth.

The system's design facilitates real-time calculation and immediate feedback to the customer. The system can perform the necessary lookups and calculations in real-time, providing the customer with a clear understanding of the redemption value of their points, in some cases before finalizing the transaction. The system's architecture is designed to be scalable and adaptable, allowing for the seamless integration of new merchants, promotional campaigns, and customer preferences as the loyalty program evolves.

As noted, the described systems and methods allow for more enhanced loyalty programs. More specifically, the described systems and methods allow financial service providers to offer more robust resource allocation schemes based on a greater variety of dynamic factors. For example, resource allocation rates can vary based on the merchant, type of merchant, type of goods and services, etc. Further, by determining the resource allocation rate based on event data at the point of sale, the described systems and methods provider greater transparency to credit card users.

Unless the context requires otherwise, throughout the specification and claims which follow, the word “comprise” and variations thereof, such as, “comprises” and “comprising” are to be construed in an open, inclusive sense, that is, as “including, but not limited to.” It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies. In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof. It should be noted that the term “coupled” used herein indicates that two elements can be directly coupled to one another or coupled to one another through one or more intermediate elements.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object-oriented paradigm. Accordingly, the program code may be written in Java, C++ or any other suitable programming language and may include modules or classes, as is known to those skilled in object-oriented programming. Alternatively, or in addition thereto, some of these elements implemented via software may be written in assembly language, machine language or firmware as needed. In either case, the language may be a compiled or interpreted language.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as describing exemplary implementations. Various modification and variations may be made to these example embodiments without departing from the spirit and scope of the invention, which is limited only by the appended claims.

What is claimed is:

1. A resource allocation system comprising:
a database storing a plurality of session types in association with a plurality of resource allocation rates; and
a processor and a memory storing instructions, the instructions, when executed by the processor, cause the processor to:
receive, from a terminal computing device, a resource allocation query comprising query session data, the query session data comprising a query terminal identifier and a query client identifier;
determine a query session type based to the query session data, the query session type being one of the plurality of session types from the database;
using the query session type, obtain a query resource allocation rate from the plurality of resource allocation rates stored in the database;
determine a first resource allocation and a second resource allocation based at least on the query session data and the query resource allocation rate; and
append a record of the first resource allocation to a first resource database associated with the client identifier and a record of the second resource allocation to a second resource allocation database associated with the client identifier.

2. The system of claim 1, wherein the instructions further cause the processor to:
compare the query session type with the plurality of session types;
in response to determining that the query session type matches a particular session type of the plurality of session types, use the resource allocation rate associated with the particular session type as the session resource allocation rate; and
otherwise, assign a default resource allocation rate to the query resource allocation rate.

3. The system of claim 2, wherein the query session data comprises a query session date and time, and the instructions further cause the processor to:
determine whether the session date and time falls within a pre-defined date and time period;
in response to determining that the session date and time falls within the pre-defined date and time period, use a limited time resource allocation rate as the query resource allocation rate; and
otherwise, use a standard resource allocation rate as the query resource allocation rate.

4. The system of claim 3, wherein the limited time resource allocation rate is a pre-defined multiplier applied to the standard resource allocation rate.

5. The system of claim 1, wherein the database further comprises a plurality of terminal identifiers in association with the plurality of session types; and wherein the instructions further cause the processor to:
compare the query terminal identifier with the plurality of terminal identifiers;
in response to determining that the query terminal identifier matches a particular terminal identifier of the plurality of terminal identifiers, use the session type associated with the particular terminal identifier as the query session type; and
otherwise assign a default session type to the query session type.

6. The system of claim 1, further comprising the database further comprises a plurality of terminal category codes in association with the plurality of session types; and wherein:
the query session data comprises a query terminal category code; and
the instructions further cause the processor to:
compare the query terminal category code with the plurality of terminal category codes;
in response to determining that the query terminal category code matches a particular terminal category code of the plurality of terminal category codes, use the session type associated with the particular terminal category code as the query session type; and
otherwise assign a default session type to the query session type.

7. The system of claim 1, wherein the query session data comprises a query first resource value, and the instructions further cause the processor to:
determine a client second resource amount from the second resource allocation database associated with the client identifier;
generate a client second resource value based on the client second resource amount and the query resource allocation rate;
compare the query first resource value to the client second resource value;
in response to determining that the client second resource value is at least the query first resource value, use the query first resource value as a proposed second resource allocation and nil as a proposed first resource allocation; and
otherwise, in response to determining that the client second resource value is less than the query first resource value, use the client second resource value as the proposed second resource allocation and a difference between the query first resource value and the client second resource value as the proposed first resource allocation.

8. The system of claim 7, wherein the instructions further cause the processor to:
transmit the proposed first resource allocation and the proposed second resource allocation to the terminal computing device for either approval or rejection prior to appending the record of the first resource allocation to the first resource database and the record of the second resource allocation to the second resource allocation database;
in response to receiving approval of the proposed first resource allocation and the proposed second resource allocation from the terminal computing device, use proposed first resource allocation as the first resource allocation and the proposed second resource allocation as the second resource allocation; and
otherwise, in response to receiving rejection of the proposed first resource allocation and the proposed second resource allocation from the terminal computing device, generate an alternative proposed first resource allocation and an alternative proposed second resource allocation.

9. The system of claim 1, wherein the instructions further cause the processor to append a record of the query first resource value to a first resource allocation database associated with the terminal identifier.

10. A computer-implemented method for resource allocation, the method comprising:
receiving a resource allocation query comprising query session data, the query session data comprising a query terminal identifier and a query client identifier;
determining a query session type based to the query session data, the query session type being one of a plurality of session types stored in a database;
using the query session type, obtaining a query resource allocation rate from a plurality of resource allocation rates stored in association with the plurality of session types in the database;
determining a first resource allocation and a second resource allocation based at least on the query session data and the query resource allocation rate; and
appending a record of the first resource allocation to a first resource database associated with the client identifier and a record of the second resource allocation to a second resource allocation database associated with the client identifier.

11. The method of claim 10, further comprising:
comparing the query session type with the plurality of session types;
in response to determining that the query session type matches a particular session type of the plurality of session types, using the resource allocation rate associated with the particular session type as the session resource allocation rate; and
otherwise, assigning a default resource allocation rate to the query resource allocation rate.

12. The method of claim 11, wherein the query session data comprises a query session date and time, and the method further comprises:
determining whether the session date and time falls within a pre-defined date and time period;
in response to determining that the session date and time falls within the pre-defined date and time period, using a limited time resource allocation rate as the query resource allocation rate; and
otherwise, using a standard resource allocation rate as the query resource allocation rate.

13. The method of claim 12, wherein the limited time resource allocation rate is a pre-defined multiplier applied to the standard resource allocation rate.

14. The method of claim 10, further comprising:
comparing the query terminal identifier with a plurality of terminal identifiers stored in association with the plurality of session types in the database;
in response to determining that the query terminal identifier matches a particular terminal identifier of the plurality of terminal identifiers, using the session type associated with the particular terminal identifier as the query session type; and
otherwise assigning a default session type to the query session type.

15. The method of claim 10, wherein the query session data comprises a query terminal category code, and the method further comprises:
comparing the query terminal category code with a plurality of terminal category codes stored in association with the plurality of session types in the database;
in response to determining that the query terminal category code matches a particular terminal category code of the plurality of terminal category codes, using the session type associated with the particular terminal category code as the query session type; and
otherwise assigning a default session type to the query session type.

16. The method of claim 10, wherein the query session data comprises a query first resource value, and the method further comprises:
determining a client second resource amount from the second resource allocation database associated with the client identifier;
generating a client second resource value based on the client second resource amount and the query resource allocation rate;
comparing the query first resource value to the client second resource value;
in response to determining that the client second resource value is at least the query first resource value, using the query first resource value as a proposed second resource allocation and nil as a proposed first resource allocation; and
otherwise, in response to determining that the client second resource value is less than the query first resource value, using the client second resource value as the proposed second resource allocation and a difference between the query first resource value and the client second resource value as the proposed first resource allocation.

17. The method of claim 16, further comprising:
transmitting the proposed first resource allocation and the proposed second resource allocation for either approval or rejection prior to appending the record of the first resource allocation to the first resource database and the record of the second resource allocation to the second resource allocation database;
in response to receiving approval of the proposed first resource allocation and the proposed second resource allocation, using proposed first resource allocation as the first resource allocation and the proposed second resource allocation as the second resource allocation; and
otherwise, in response to receiving rejection of the proposed first resource allocation and the proposed second resource allocation, generating an alternative proposed first resource allocation and an alternative proposed second resource allocation.

18. The method of claim 10, further comprising appending a record of the query first resource value to a first resource allocation database associated with the terminal identifier.

19. A non-transitory computer-readable medium storing computer-executable instructions that, when executed by a processor, cause the processor to:
receive a resource allocation query comprising query session data, the query session data comprising a query terminal identifier and a query client identifier;
determine a query session type based to the query session data, the query session type being one of a plurality of session types stored in a database;
using the query session type, obtain a query resource allocation rate from a plurality of resource allocation rates stored in association with the plurality of session types in the database;
determine a first resource allocation and a second resource allocation based at least on the query session data and the query resource allocation rate; and
append a record of the first resource allocation to a first resource database associated with the client identifier and a record of the second resource allocation to a second resource allocation database associated with the client identifier.
